(19) United States
(12) Patent Application Publication
(10) Pub. No.: US 2026/0323203 A1
(43) Pub. Date: Oct. 15, 2026

(54) MICROPHONE

(71) Applicant: Audio-Technica Corporation, Tokyo (JP)

(72) Inventor: Takahiro IMAMURA, Tokyo (JP)

(21) Appl. No.: 18/711,968

(22) PCT Filed: Sep. 14, 2023
(86) PCT No.: PCT/JP2023/033560

§ 371 Date: May 17, 2026

(30) Foreign Application Priority Data
Nov. 25, 2022 (JP) 2022-188161

(51) Int. Cl. H04R 1/28; H04R 1/08

(52) U.S. Cl. CPC H04R 1/2876; H04R 1/083

(57) ABSTRACT

Provided is a microphone that reduces noise transmitted from a housing with a simple configuration.
A microphone 1 including a microphone unit 20; a unit holding member 30 that holds the microphone unit; a grip 40 that has a cylindrical shape and houses the unit holding member inside; and a buffer member 60 that is interposed between the unit holding member and the grip, wherein the buffer member is held in a floating manner in a space S of which at least a part is partitioned by the grip.

### TECHNICAL FIELD

The present invention relates to a microphone.

### BACKGROUND ART

A handheld microphone that is gripped by a user's hand and used is known. A rubbing sound or an impact sound when gripped may be transmitted to a housing gripped by the user. As a result of the microphone collecting the vibration and the rubbing sound, noise or an unpleasant sound may be included in the collected sound.

Until now, for example, a unidirectional dynamic microphone having a shock mount that supports a microphone unit 20 on a support housing has been disclosed (See, for example, Patent Literature 1). In addition, Patent Literature 2 discloses a microphone device including a shock mount member formed of an elastic material, in which a microphone unit 20 is supported inside a microphone case via the shock mount.

However, vibration transmitted via the shock mount may be collected as noise by the microphone unit 20, and it cannot be said that noise from the housing can be sufficiently removed.

### CITATION LIST

### Patent Literature

Patent Literature 1: JP6432051B

Patent Literature 2: JP6516626B

### SUMMARY OF INVENTION

### Technical Problem

An object of the present invention is to provide a microphone having a simple configuration and less noise transmitted from a housing.

### Solution to Problem

A microphone according to the present invention includes: a microphone unit; a unit holding member that holds the microphone unit; a grip that has a cylindrical shape and houses the unit holding member inside; and a buffer member that is interposed between the unit holding member and the grip, in which the buffer member is held in a floating manner in a space of which at least a part is partitioned by the grip.

### Advantageous Effects of Invention

According to the present invention, it is possible to provide a microphone with a simple configuration and less noise transmitted from a housing.

### BRIEF DESCRIPTION OF DRAWINGS

FIG. 1 is a longitudinal cross-sectional view illustrating an embodiment of a microphone according to the present invention.

FIG. 2 is an exploded perspective view of the microphone.

FIG. 3 is a perspective view of a shock mount included in the microphone.

FIG. 4 is a plan view of the shock mount.

FIG. 5 is a cross-sectional view taken along line C-C of the shock mount.

FIG. 6 is a partially enlarged view of A in FIG. 1.

FIG. 7 is a transverse cross-sectional view illustrating a state in which the shock mount is disposed inside a grip included in the microphone.

FIG. 8 is a partially enlarged view of D in FIG. 7.

FIG. 9 is a perspective view of a support bush included in the microphone, in which (a) is a perspective view from a front surface side, and (b) is a perspective view from a rear surface side.

FIG. 10 is a transverse cross-sectional view illustrating a state in which the support bush is disposed inside the grip.

FIG. 11 is a partially enlarged view of E in FIG. 10.

FIG. 12 is a longitudinal cross-sectional view of the support bush.

FIG. 13 is a partially enlarged view of B in FIG. 1.

FIG. 14 is a graph illustrating frequency response characteristics of a microphone including the shock mount and a microphone in a related art.

FIG. 15 is a graph illustrating frequency response characteristics of a microphone including the support bush and a microphone in a related art.

FIG. 16 is a longitudinal cross-sectional view of a microphone in a related art.

FIG. 17 is a perspective view of a shock mount included in the microphone according to a related art.

FIG. 18 is a partially enlarged view of F in FIG. 16.

FIG. 19 is a perspective view of a support bush included in the microphone.

FIG. 20 is a partially enlarged view of G in FIG. 16.

FIG. 21 is a longitudinal cross-sectional view of a microphone in another related art.

### DESCRIPTION OF EMBODIMENTS

Hereinafter, embodiments of a microphone according to the present invention will be described with reference to the drawings. The microphone according to the present invention is a handheld microphone that is mainly used by a user holding a housing. Note that, in the following description, the axial direction of a microphone 1 is also referred to as the z direction, and a direction orthogonal to the z direction is also referred to as the x direction and the y direction. Further, the surface facing the +z direction is also referred to as a front surface, and the surface facing the −z direction is also referred to as a rear surface. Note that the arrangement direction of the microphone is not limited to this direction.

### Microphone

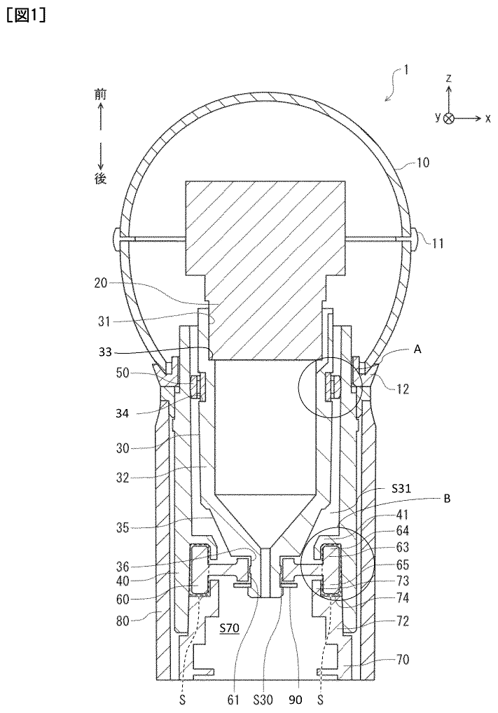

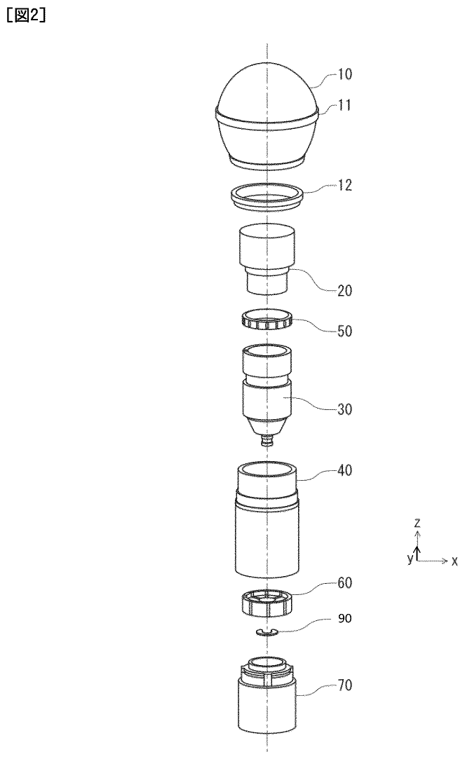

As illustrated in FIGS. 1 and 2, the microphone 1 mainly includes a head case 10, a microphone unit 20, a cavity cup 30, a grip 40, a shock mount 50, a support bush 60, a holder 70, and a grip housing 80.

### Head Case 10

The head case 10 constitutes an upper end portion of the microphone 1 and has an opening through which sound waves pass. The head case 10 is made of a perforated plate such as punched metal or a net called a guard mesh. In this embodiment, the head cases 10 are paired vertically and are coupled to each other via coupling rings 11. A lower end portion of head case 10 is connected to the grip 40 by appropriate annular fixing member 12.

### Microphone Unit 20

The microphone unit 20 collects sound waves from a sound source. The microphone unit 20 is, for example, a dynamic microphone unit 20. Note that the microphone unit 20 may be of an electrostatic type (condenser type). Further, the directivity of the microphone unit 20 is, for example, unidirectivity, but may be different directivity.

### Cavity Cup 30

As illustrated in FIG. 1, the cavity cup 30 is a substantially cylindrical member that holds the microphone unit 20 at the upper end portion thereof. The cavity cup 30 mainly includes a unit accommodating portion 31, a central portion 32, a stepped portion 33, a concave portion 34, a truncated conical portion 35, and a small diameter portion 36.

The unit accommodating portion 31 is a portion that accommodates the rear end of the microphone unit 20 at the upper end portion of the cavity cup 30. The unit accommodating portion 31 has an inner diameter larger than that of the central portion 32 on the inner circumferential surface of the cavity cup 30. As a result, the stepped portion 33 is formed between the unit accommodating portion 31 and the central portion 32. When the rear end of the microphone unit 20 abuts on the stepped portion 33, the position the microphone unit 20 in the front-rear direction is defined. The cavity cup 30 is an example of a unit holding member.

The concave portion 34 is a portion formed over the entire circumference in the vicinity of the center of the cavity cup 30 in the axial direction. A shock mount 50 in an annular shape is fitted in the concave portion 34.

The truncated conical portion 35 is a portion gradually tapered toward the rear end. The truncated conical portion 35 connects the central portion 32 and the small diameter portion 36.

The small diameter portion 36 is a cylindrical portion constituting the rear end of the cavity cup 30 and having a radius smaller than that of the central portion 32. The small diameter portion 36 is inserted into a support bush 60 to be described later and is supported by the support bush 60. Further, an E-ring 90 is fitted to the rear end of the small diameter portion 36. The E-ring 90 restricts the movement of the support bush 60 in the axial direction.

### Grip 40

The grip 40 is a substantially cylindrical member that houses the cavity cup 30 inside.

A hook-shaped portion 41 having a hook shape in a cross-sectional view is formed on an inner circumferential surface of the grip 40. The hook-shaped portion 41 is formed over the entire circumference of the inner circumferential surface and has an annular shape. A front convex portion 64 of the support bush 60 described later is accommodated and held in the hook-shaped portion 41.

### Shock Mount 50

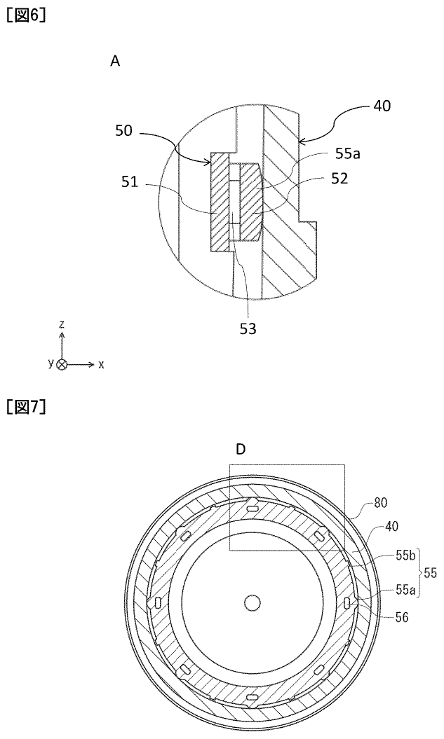

As illustrated in FIG. 1, the shock mount 50 is a substantially annular member interposed between the cavity cup 30 and the grip 40. The shock mount 50 has an elastic force, and is formed of an elastic material such as various elastomers and rubber materials. As illustrated in FIGS. 1 and 6, the outer edge of the shock mount 50, that is, the outer circumferential surface of the outer wall portion 52 faces the inner wall of the grip 40. The shock mount 50 is a first example of a buffer member.

The shock mount 50 is bilaterally symmetrical in the front-rear direction in the axial direction. According to the configuration in which the shock mounts 50 are bilaterally symmetrical, the structure is simple, and thus manufacturing and assembling are easy.

As illustrated in FIGS. 1 to 5, the shock mount 50 mainly includes the inner wall portion 51, the outer wall portion 52, a connecting portion 53, a recess 54, a plurality of ribs 55, and a plurality of holes 56.

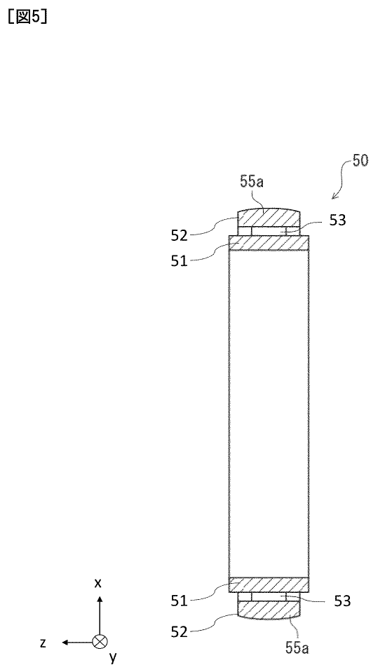

In particular, as illustrated in FIG. 4, the inner wall portion 51 of the shock mount 50 is an annular portion constituting the inner circumferential surface of the shock mount 50. The outer wall portion 52 is an annular portion constituting the outer circumferential surface of the shock mount 50. In particular, as illustrated in FIG. 5, in the present embodiment, the width of the outer wall portion 52 in the axial direction is smaller than that of the inner wall portion 51.

In particular, the connecting portion 53 illustrated in FIG. 4 is a substantially annular ring that connects the inner wall portion 51 and the outer wall portion 52 so as to be substantially concentric. The connecting portion 53 is a flat plate-shaped annular ring thinner than the inner wall portion 51 and the outer wall portion 52, and as a result, an annular recess 54 having the connecting portion 53 as a bottom is formed between the inner wall portion 51 and the outer wall portion 52.

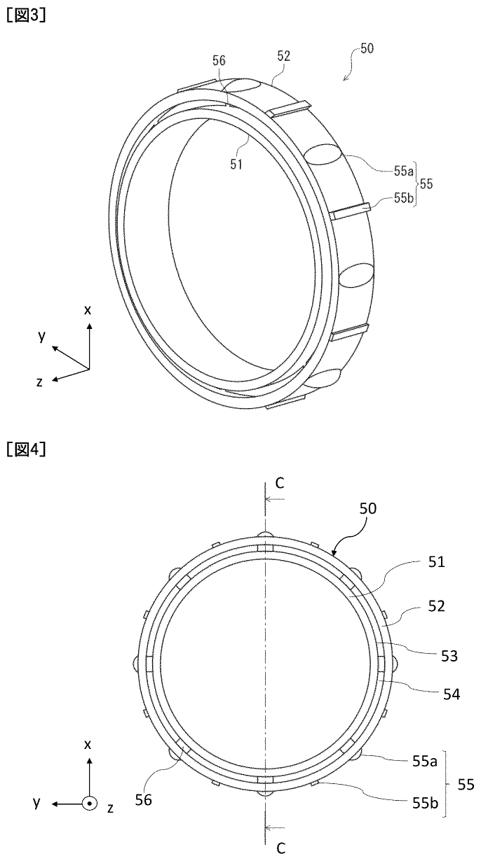

As illustrated in FIGS. 3 and 4, a plurality of ribs 55 is formed on the outer wall portion 52 of the shock mount 50. The plurality of ribs 55 are formed at substantially equal intervals on the circumference. The plurality of ribs 55 abut on the inner wall of the grip 40 in response to vibration and elastically deform to absorb the vibration of the grip 40.

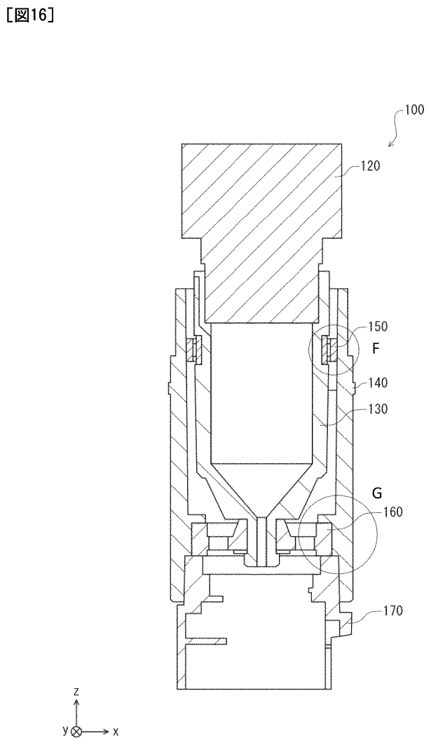

Here, a microphone 100 of a related art will be described with reference to FIGS. 16 to 18. The microphone 100 of the related art mainly includes a head case (not illustrated), a microphone unit 120, a cavity cup 130, a grip 140, a shock mount 150, a support bush 160, a holder 170, and a grip housing (not illustrated).

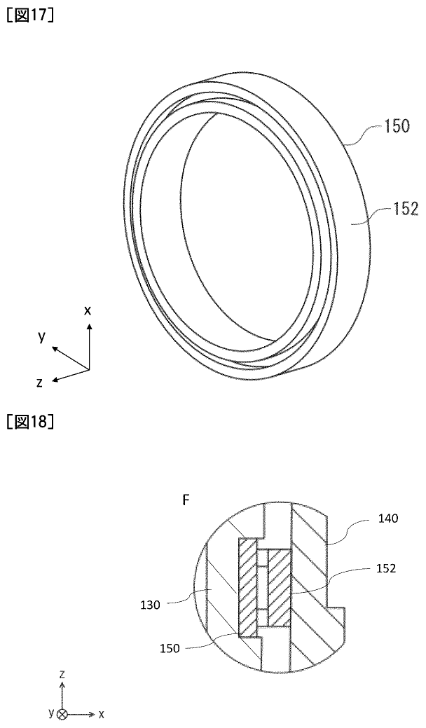

As illustrated in FIG. 17, the shock mount 150 in the related art is a substantially annular member, and the outer edge 152 is smooth. Therefore, as illustrated in FIG. 18, the outer edge 152 of the shock mount 150 is in surface contact with the inner wall of the grip 140.

On the other hand, in the microphone 1 according to the present invention, since the rib 55 of the shock mount 50 comes into contact with the inner wall of the grip 40 as illustrated in FIG. 6, a contact area with the grip 40 is smaller than that of the shock mount 150 in the related art. Therefore, with the shock mount 50 of the present invention, transmission of noise caused by rubbing against the grip 40 can be reduced.

In addition, since the shock mount 50 receives the vibration of the grip 40 with an area smaller than that of the shock mount 150, the shock mount 50 is easily deformed as compared with the shock mount 150. Therefore, with the shock mount 50 of the present invention, the vibration of the grip 40 can be sufficiently absorbed.

As illustrated in FIGS. 3 and 4, the plurality of ribs 55 include at least a plurality of first ribs 55a and a plurality of second ribs 55b having different protrusion amounts. More specifically, the protrusion amount of the second rib 55b is smaller than that of the first rib 55a. The first ribs 55a and the second ribs 55b are alternately disposed along the circumference of the shock mount 50. According to this configuration, when the grip 40 is not vibrating or is vibrating slightly, at least one of first ribs 55a abuts on the inner wall of grip 40. When a large impact is applied to the grip 40 and the grip greatly vibrates, the first rib 55a is pressed and crushed. Then, both the second rib 55b and the first rib 55a abut on the inner wall of the grip 40 to receive the vibration of the grip 40.

That is, according to the configuration in which the first rib 55a and the second rib 55b having different protrusion amounts receive vibration in a stepwise manner, even when a large impact is applied to the microphone 1, the impact can be alleviated and transmission of vibration noise can be reduced. In addition, since the shock mount 50 in the present invention is different from the shock mount 150 in the related art only in the detailed shape and can be manufactured in a similar process, transmission of vibration noise can be reduced without increasing manufacturing cost. In the present embodiment, the protrusion amount of the rib 55 is two types, but may be three or more types.

As illustrated in FIGS. 5 and 6, the protruding surfaces of the plurality of first ribs 55a are convex curved surfaces. According to this configuration, the contact area between the first rib 55a and the inner wall of the grip 40 is reduced as compared with the configuration in which the protruding surface of the first rib 55a is flat, and the vibration noise due to rubbing can be further reduced. Further, according to the configuration in which the protruding surface of the first rib 55a is a curved surface, it is easy to insert the shock mount 50 into the grip 40 in the assembly process.

The plurality of second ribs 55b are substantially rectangular parallelepipeds, and the protruding surfaces of the plurality of second ribs 55b are flat. According to this configuration, manufacturing is easier than a configuration in which the protruding surfaces of all the ribs 55 are curved surfaces.

In the present embodiment, the protruding surface of the first rib 55a having a relatively large protrusion amount is a convex curved surface, and the protruding surface of the second rib 55b having a relatively small protrusion amount is flat. However, the technical scope of the present invention is not limited thereto, and the protruding surface of the rib having a relatively large protrusion amount may be flat, or the protruding surface of the rib having a relatively small protruding surface may be a convex curved surface. Further, the protrusion amount and the protruding surface shape may not correspond to each other.

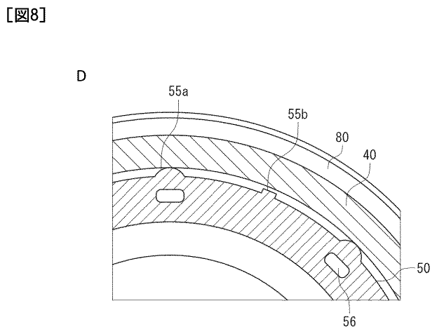

As illustrated in FIGS. 4, 7, and 8, the shock mount 50 has a plurality of holes 56 penetrating the connecting portion 53 in the axial direction. The plurality of holes 56 are bored at equal intervals on the same circumference, for example. With the plurality of holes 56, the radial elasticity of the shock mount 50 can be reduced and the shock mount can be easily deformed. As a result, the shock mount 50 absorbs the vibration of the grip 40, so that transmission to the microphone unit 20 can be reduced.

Further, the plurality of holes 56 may be formed at positions corresponding to the plurality of ribs 55. In particular, the plurality of holes 56 may be formed at positions corresponding to the first ribs 55a. According to this configuration, the hole 56 reduces the elasticity of the shock mount 50 in the vicinity of the rib 55. As a result, the shock mount 50 can be easily deformed against the drag force from the grip 40 applied via the rib 55, so that the noise generated by the vibration of the grip 40 can be further reduced.

### Support Bush 60

As illustrated in FIG. 1, the support bush 60 is a disk-shaped member interposed between the cavity cup 30 and the grip 40. The outer wall portion 63 of the support bush 60 faces the inner wall of the grip 40. The support bush 60 is a second example of the buffer member.

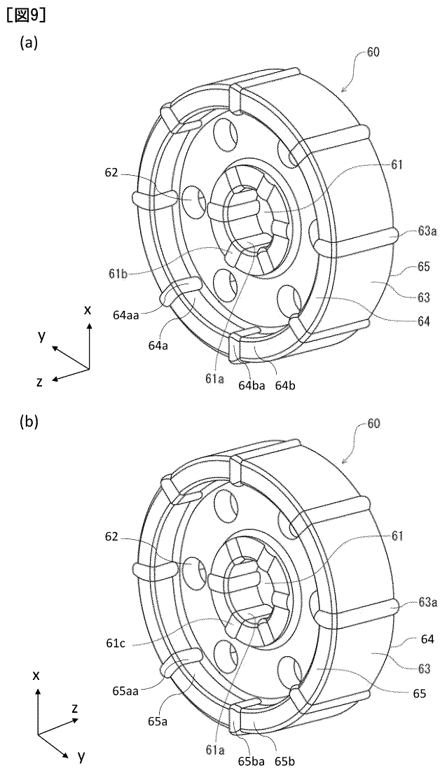

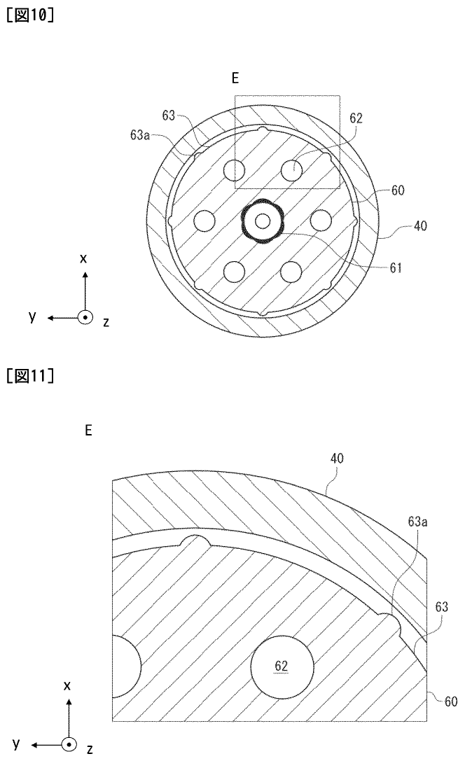

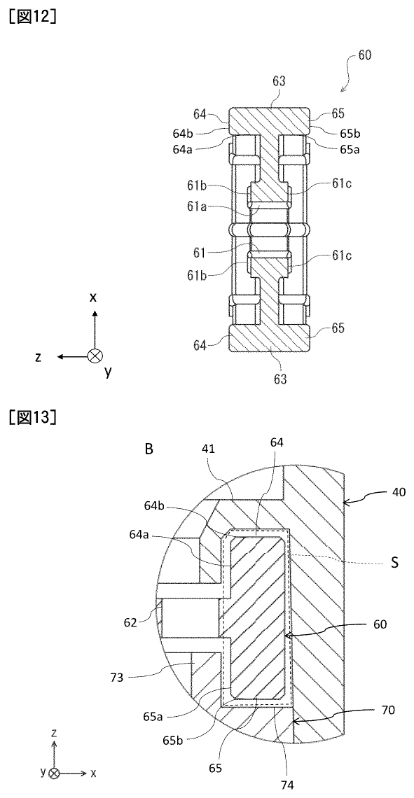

As illustrated in FIGS. 9 and 10, the support bush 60 mainly includes a first through hole 61, a second through hole 62, an outer wall portion 63, a front convex portion 64, and a rear convex portion 65. Note that the support bush 60 in the present embodiment is bilaterally symmetrical in the front-back direction in the axial direction in the assembled state, and the front convex portion 64 and the rear convex portion 65 are distinguished for convenience in accordance with their orientation in the assembled state. According to the configuration in which the support bush 60 is bilaterally symmetrical, it is easy to manufacture and assemble.

The first through hole 61 is formed substantially at the center in the axial direction of the support bush 60. As illustrated in FIG. 1, the small diameter portion 36 of the cavity cup 30 is inserted into the first through hole 61. That is, the inner wall of the first through hole 61 faces the outer wall of the small diameter portion 36. The diameter of the small diameter portion 36 may be smaller than that of the first through hole 61, and a gap S30 may be formed between the cavity cup 30 and the small diameter portion 36.

The second through holes 62 are a plurality of holes provided on concentric circles of the first through holes 61 and penetrating in the axial direction. The second through holes 62 are provided at substantially equal intervals along the circumferential direction of the support bush 60. In the present embodiment, the number of the second through holes 62 is six, which is different from the number of the ribs 61a, but may be the same.

In addition, as illustrated in FIG. 1, the second through hole 62 forms a flow path that communicates the space S31 between the cavity cup 30 and the grip 40 with the space S70 in the holder 70.

As illustrated in FIG. 9 (a), a plurality of ribs 61a protruding inward in the circumferential direction is disposed on the inner wall of the first through hole 61. Although the number of ribs 61a is six in the present embodiment, the number is arbitrary. The rib 61a faces the small diameter portion 36. Therefore, when the support bush 60 abuts on the cavity cup 30, the rib 61a abuts on the small diameter portion 36. According to such a configuration, since the contact area between the support bush 60 and the cavity cup 30 is smaller than that of the microphone 100 of the related art, transmission of vibration noise through the support bush 60 can be reduced.

As illustrated in FIG. 9 (a) and 9 (b), a plurality of ribs 61b and 61c protruding in the axial direction are disposed around the front surface side and the rear surface side of the first through hole 61, respectively. In the drawing, the plurality of ribs 61b and 61c are provided at positions continuous with the rib 61a, but any of the ribs 61a, 61b, and 61c may be provided at mutually different positions in the circumferential direction. The plurality of ribs 61b provided on the front surface side of the support bush 60 face the lower end of the truncated conical portion 35 of the cavity cup 30. In addition, the plurality of ribs 61c provided on the rear surface side of the support bush 60 faces the E-ring 90. Therefore, even when vibration in the axial direction is applied, the rib 61b and the cavity cup 30 or the rib 61c and the E-ring 90 abut on each other. That is, according to the configuration of the rib 61b and the rib 61c, the contact area can be reduced as compared with the configuration in which the front surface side periphery and the rear surface side periphery of the first through hole 61 are flat.. As a result, transmission of vibration noise due to rubbing can be reduced.

As illustrated in FIG. 9 (a), a plurality of ribs 63a protruding outward in the circumferential direction is disposed on the outer wall portion 63 of the support bush 60. Although the number of ribs 63a is eight in the present embodiment, the number is arbitrary.

As illustrated in FIGS. 10 and 11, the rib 63a faces the inner circumferential surface of the grip 40. Therefore, when the support bush 60 abuts on the grip 40, the rib 63a abuts on the inner circumferential surface of the grip 40. According to this configuration, since the contact area between the support bush 60 and the grip 40 is smaller than when the outer wall portion 63 is flat, transmission of vibration noise through the support bush 60 can be reduced.

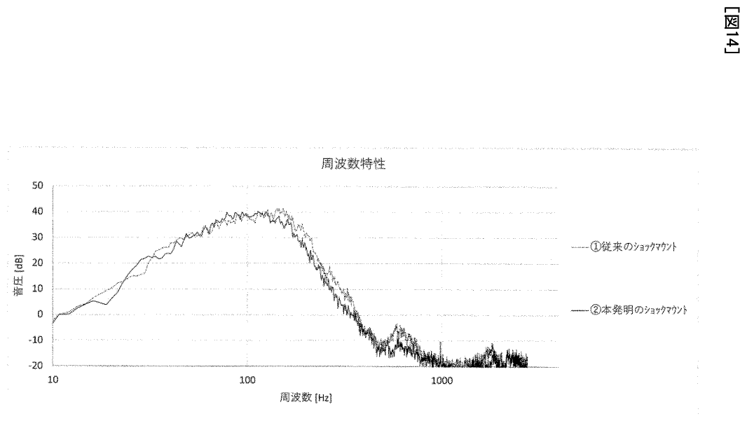

The front convex portion 64 protrudes toward the front end side on the front surface of the support bush 60. The front convex portion 64 is formed in an annular shape over the entire circumference of the support bush 60. The front convex portion 64 is held in a space S (see FIGS. 1 and 13) partially partitioned by the hook-shaped portion 41 of the grip 40. A detailed configuration of the space S will b described later.

A rib 64aa is disposed on the inner surface 64a of the front convex portion 64. Furthermore, a rib 64ba protruding in the axial direction is disposed on the protruding surface 64b of the front convex portion 64. That is, the rib 64aa and the rib 64ba face the inner surface of the hook-shaped portion 41. Therefore, for a radial component of the vibration of the grip 40, the rib 64aa abuts on the inner surface of the hook-shaped portion 41. Further, for the axial component of the vibration of the grip 40, the rib 64ba abuts on the inner surface of the hook-shaped portion 41. Also with this configuration, the contact area between the support bush 60 and the hook-shaped portion 41 can be reduced, and the rubbing sound can be reduced.

As illustrated in FIG. 9 (b), the rear convex portion 65 protrudes toward the rear end side on the rear surface of the support bush 60. The rear convex portion 65 is formed in an annular shape over the entire circumference of the support bush 60. A rib 65aa is disposed on the inner surface 65a of the rear convex portion 65. Furthermore, a rib 65ba protruding in the axial direction is disposed on the protruding surface 65b of the rear convex portion 65.

As illustrated in FIG. 13, the inner surface 65a of the rear convex portion 65 faces a second small diameter portion 73 of the holder 70 described later. Further, the protruding surface 65b of the rear convex portion 65 faces a shoulder portion 74 of the holder 70. Therefore, for a radial component of the vibration of the grip 40, the rib 65aa abuts on the second small diameter portion 73. Further, for the axial component of the vibration of the grip 40, the rib 65ba abuts on the shoulder portion 74. Also with this configuration, the contact area between the support bush 60 and the holder 70 can be reduced, and the rubbing sound can be reduced.

### Holder 70

As illustrated in FIG. 1, the holder 70 is a cylindrical member that engages with a rear end portion of the grip 40. The holder 70 mainly includes a base portion 71, a first small diameter portion 72, a second small diameter portion 73, and the shoulder portion 74.

The base portion 71 is a cylindrical portion forming an outer edge of the holder 70.

The first small diameter portion 72 is a cylindrical portion having an outer diameter smaller than that of the base portion 71, and is formed at the front end portion of the holder 70. Further, the second small diameter portion 73 is a cylindrical portion having an outer diameter smaller than that of the first small diameter portion 72, and is formed at the front end portion of the first small diameter portion 72. The shoulder portion 74 in an annular shape is formed between the first small diameter portion 72 and the second small diameter portion 73 due to a difference in outer diameter.

The space S in an annular shape is partitioned by the hook-shaped portion 41, the inner circumferential surface of the grip 40, the outer circumferential surface of the second small diameter portion 73, and the shoulder portion 74. The outer wall portion 63 of the support bush 60 is accommodated in this space S, so that the support bush 60 is held in a floating manner in the space S. That is, the support bush 60 is not fixed to any of the cavity cup 30, the grip 40, and the holder 70. In addition, the outer wall portion 63 of the support bush 60 is slightly smaller than the volume of the space S. That is, the support bush 60 may have a gap with the inner wall of the space S. As a result, the outer wall portion 63 moves in the space S according to the direction of the force due to gravity or vibration, and appropriately abuts on any one of the hook-shaped portion 41 constituting the inner wall of the space S, the inner circumferential surface of the grip 40, the outer circumferential surface of the second small diameter portion 73, and the shoulder portion 74.

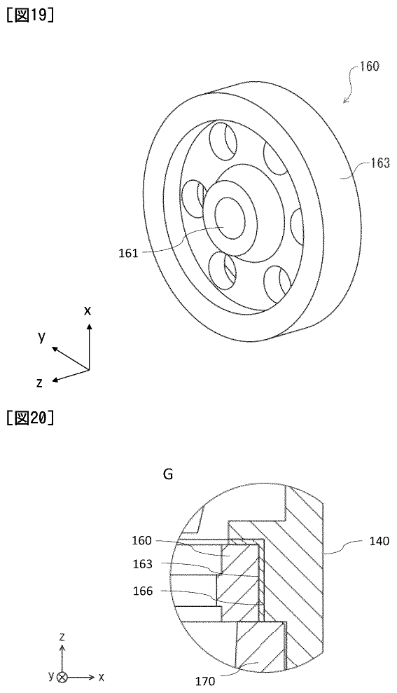

Here, structures of microphones 100 and 200 of the related art will be described with reference to FIGS. 19 to 21.

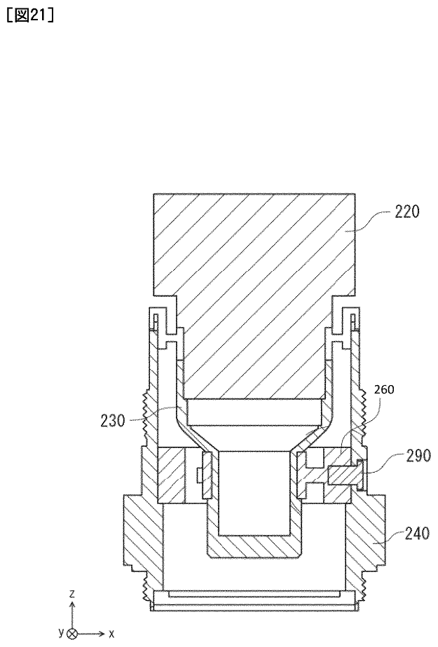

As illustrated in FIGS. 19 and 20, in the support bush 160 included in the microphone 100 of the related art, the inner circumferential surface and the outer wall 163 of the first through hole 161 are flat. As a result, the outer wall 163 and the grip 140 are brought into surface contact with each other. Similarly, the first through hole 161 of the support bush 160 and the cavity cup 30 are also in surface contact. Also, as illustrated in FIG. 20, the outer wall 163 and the grip 140 are bonded to each other by an adhesive 166.

The microphone 200 according to another example of the related art illustrated in FIG. 21 mainly includes a microphone unit 220, a cavity cup 230, a grip 240, and a support bush 260. Here, the grip 240 and the support bush 260 are firmly connected by a screw 290.

According to the configuration of the microphones 100 and 200 of the related art, the cavity cups 130 (see FIGS. 16) and 230 are stably held in the grips 140 and 240 even against severe impact. On the other hand, vibration of the grips 140 and 240 may be transmitted to the support bushes 160 and 260, and the microphone units 120 and 220 may collect sound as vibration noise.

In contrast to such a configuration of the related art, in the microphone 1 according to the present invention, the support bush 60 is not bonded to either the cavity cup 30 or the grip 40 and is held in a floating manner. Therefore, the support bush 60 abuts on or separates from each inner wall constituting the space S according to the vibration of the grip 40. That is, the support bush 60 can reduce the vibration noise collected by the microphone unit 20 without excessively transmitting the vibration of the grip 40 to the microphone unit 20. In addition, since the support bush 60 is held in a floating manner in the space S, the support bush abuts on the inner wall of the space S according to the vibration, so that the vibration can be appropriately absorbed.

### Grip Housing 80

The grip housing 80 is a cylindrical housing that covers the outer circumference of the grip 40. The grip housing 80 is a member directly gripped by the user, and receives impact and vibration associated with use. The grip housing 80 is coupled to the head case 10 and the grip 40 via a fixing member 12.

### Frequency Response Characteristics

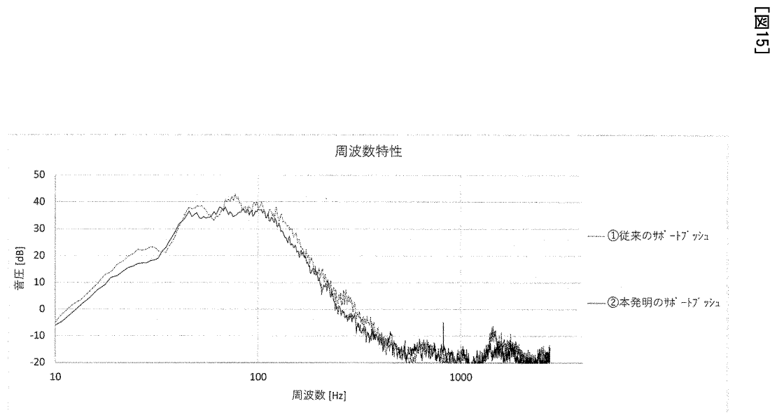

FIGS. 14 and 15 illustrate frequency response characteristics of sound collected by the microphone 1 when the grip housing of the microphone 1 is rubbed. In FIGS. 14 and 15, the horizontal axis represents the frequency, and the vertical axis represents the output level (dBV).

FIG. 14 is a graph illustrating frequency response characteristics of the microphone 1 according to the present invention by a solid line and frequency response characteristics of the microphone 100 including the shock mount 150 of the related art by a broken line. According to the drawing, in the microphone 1, a sound pressure of vibration noise collected in a frequency band of 150 Hz to 350 Hz is smaller than that of the microphone 100. That is, with the shock mount 50 included in the microphone 1 according to the present invention, it is possible to suppress sound collection 41 vibration noise transmitted from the grip housing 80.

FIG. 15 is a graph illustrating frequency response characteristics of the microphone 1 according to the present invention by a solid line and frequency response characteristics of the microphone 200 including the support bush 260 of the related art by a broken line. According to the drawing, in the microphone 1, a sound pressure of vibration noise collected in a frequency band of 150 Hz to 400 Hz is smaller than that of the microphone 100. That is, according to the structure of the support bush 60 included in the microphone 1 according to the present invention, it is possible to suppress sound collection of vibration noise transmitted from the grip housing 80.

According to the embodiment described above, it is possible to provide a microphone with a less noise transmitted from a housing.

Although the present invention has been described using the embodiments, the technical scope of the present invention is not limited to the scope described in the above embodiments, and various modifications and changes can be made within the scope of the gist of the present invention.

### REFERENCE SIGNS LIST

1 microphone
10 head case
20 microphone unit
30 cavity cup (unit holding member)
31 unit accommodating portion
40 grip
50 Shock mount (buffer member, second buffer member)
55 rib
55a first rib
55b second rib
56 hole
60 support bush (buffer member)
61 first through hole
61a rib
62 second through hole
63 Outer wall portion
63a rib
64 front convex portion (convex portion)
64a inner surface
64aa rib
64b protruding surface
64ba rib
65 rear convex portion (convex portion)
65a inner surface
65aa rib
65b protruding surface
65ba rib
70 holder
71 base portion
72 first small diameter portion
73 second small diameter portion
74 shoulder portion
80 grip housing
90 E-ring
S space
100 microphone
150 shock mount
160 support bush
200 microphone
240 grip
250 shock mount
260 support bush
290 screw

1. A microphone comprising:
a microphone unit;
a unit holding member that holds the microphone unit;
a grip that has a cylindrical shape and houses the unit holding member inside; and
a buffer member that is interposed between the unit holding member and the grip, wherein
the buffer member is held in a floating manner in a space of which at least a part is partitioned by the grip.

2. The microphone according to claim 1, wherein
the buffer member has a front convex portion protruding toward a front end side at an outer edge portion in a radial direction, and
a hook-shaped portion having a hook-shape in a cross-sectional view is formed on an inner circumferential surface of the grip, and the hook-shaped portion forms a part of the space, and
the front convex portion is held inside the hook-shaped portion.

3. The microphone according to claim 1, further comprising:
a holder that engages with a rear end portion of the grip, wherein
at least a part of the space is partitioned by the grip and the holder.

4. The microphone according to claim 3, wherein
the buffer member has a rear convex portion protruding toward a rear end side at an outer edge portion in a radial direction,
at a front end portion of the holder,
a first small diameter portion having an outer diameter smaller than that of a base portion of the holder, and having an outer circumference fitted inside the grip,
a second small diameter portion formed at a front end of the first small diameter portion and having an outer diameter smaller than that of the first small diameter portion, and
a shoulder portion formed between the first small diameter portion and the second small diameter portion are formed,
at least a part of the space is partitioned by an inner circumferential surface of the grip, the shoulder portion, and an outer circumferential surface of the second small diameter portion, and
the rear convex portion is held in the space.

5. The microphone according to claim 1, wherein
an outer edge portion of the buffer member includes a convex portion axially protruding forward and backward, and the convex portion is held in a floating manner in the space, and
a rib facing an inner wall of the space is formed on at least one of a protruding surface and an inner surface of the convex portion.

6. The microphone according to claim 1, wherein
a second buffer member is interposed between the unit holding member and the grip, and
a plurality of ribs are formed on an outer edge of the second buffer member facing an inner wall of the grip.
